(19) United States
(12) Patent Application Publication
(10) Pub. No.: US 2007/0218228 A1
(43) Pub. Date: Sep. 20, 2007

(54) Multilayer thermoplastic film structures

(75) Inventors: John Chi Hee Kwok, Moon Township, PA (US); David Biscan, Aliquippa, PA (US)

Correspondence Address: Gary F. Matz;NOVA Chemicals Inc., Westpointe Center, 1550 Coraopolis Heights Road, Moon Township, PA, 15108, US

(73) Assignee: NOVA Chemicals Inc.

(21) Appl. No.: 11/712,096

(22) Filed: Feb. 28, 2007

Related U.S. Application Data
(60) Provisional application No. 60/783,903, filed on Mar. 20, 2006.

(51) Int. Cl. B32B 27/08

(52) U.S. Cl. 428/35.7

(57) ABSTRACT

Packaging material comprised of a multilayer thermoplastic film structure may be used to form packaging articles, for example, stand up pouches, laminating films, and sealing/lidding stocks. The multilayer film structure contains a first layer comprised of an improved rubber modified styrenic copolymer, i.e. rubber modified styrene methyl methacrylate, a second layer comprised of a moisture barrier material, e.g. polyethylene, and a tie layer between the first and second layers made of a material selected from the group consisting of a styrene butadiene block copolymer, an ethylene vinyl acetate resin, and a maleic hydride modified ethylene vinyl acetate. An inner layer or layers of material having oxygen barrier properties, mechanical enhancement properties, or adhesive properties and a second tie layer comprising an appropriate material may be co-extruded with the first and second layers, and the tie layers for desired properties of the packaging material.

The improved rubber modified styrenic copolymer of the first layer includes a continuous phase and a dispersed phase, where A) the continuous phase contains a polymer composition resulting from the polymerization of a monomer mixture containing a styrenic monomer and an alkyl (meth)acrylate monomer in the presence of the dispersed phase; and B) the dispersed phase contains one or more block copolymer selected from diblock and triblock copolymers of styrene-butadiene, styrene-butadiene-styrene, styrene-isoprene, styrene-isoprene-styrene, partially hydrogenated styrene-isoprene-styrene. The multilayer film structure generally is relatively clear to transparent with a Haze value ranging between 0.1% and 40%, and most preferably about 10%.

### REFERENCE TO RELATED APPLICATION

This application claims the benefit of priority of U.S. Provisional Application Ser. No. 60/783,903 filed Mar. 20, 2006 entitled “Multilayer Thermoplastic Film Structures” which is herein incorporated by reference in its entirety.

### BACKGROUND OF THE INVENTION

1. Field of the Invention

The present invention relates to multilayer thermoplastic film structures for particular use as packaging material.

2. Description of the Prior Art

Thermoplastic polyolefins, such as polyethylene and polypropylene are ubiquitous items of commerce. Large volumes of these thermoplastics are extruded into sheets and films. Polyolefin films are widely used for packaging a wide variety of goods.

Thermoplastic polymers of vinyl aromatic monomers, such as styrene and alpha methyl styrene, are also well known. Such thermoplastic polymers, sometimes also referred to herein as “thermoplastic styrenic polymers”, are commonly used to provide rigid, clear packages for foods such as bakery goods, or opaque thermoformed containers for food and drink. Foamed polystyrene is often used to produce clamshell packages for take-out foods and to produce impact-resistant packages for eggs. However, polystyrene film is not in widespread use as a packaging material. Polystyrene tends to become highly oriented when extruded into thin films. This orientation may be used to generate a “splitty” film, i.e., a film with poor tear strength in the machine direction, or a film with predictable shrink behavior.

It is known to prepare co-extruded structures having a thermoplastic polyolefin layer and a thermoplastic polystyrene layer. However, it will be recognized by those skilled in the art that thermoplastic polyolefins and thermoplastic styrenic polymers have different polarities. Accordingly, it is difficult to produce such co-extruded structures with layers that adhere to one another. The prior art discloses several attempts to mitigate this adhesion problem, as briefly set out below.

U.S. Pat. No. 4,626,455 to Karabedian and assigned to Owens-Illinois teaches a two layer co-extruded structure in which a foamed polystyrene layer is adhered to a polyolefin layer. The polyolefin layer also contains polystyrene and a compatibility agent, which is preferably a styrene-butadiene block copolymer.

U.S. Pat. No. 4,440,824 to Bonis and assigned to Composite Container, Inc. teaches a multilayer co-extruded structure comprising a polyolefin layer, a high impact polystyrene layer, and an adhesive tie layer which is prepared from either ethylene-vinyl acetate copolymer or an ethylene-acrylic acid copolymer.

U.S. Pat. No. 5,219,665 to Schirmer et al. and assigned to W. R. Grace & Co. teaches a five layer film in which two outer (skin) layers of styrene butadiene copolymer are bonded to a core layer of very low density polyethylene using two ethylene-vinyl acetate tie layers. Each of the tie layers is located between the core layer and the two skin layers.

U.S. Pat. No. 4,879,177 to Boice and assigned to W. R. Grace & Co. also teaches a five layer film in which a core layer, which may be butadiene styrene copolymer, is sandwiched between two ethylene copolymer tie layers. The outer or skin layers of this structure are ethylene propylene copolymers, polypropylene or blends thereof.

As stated herein above, one of the problems with the aforesaid films is that the layers have a tendency to split apart or that these films may not have the clarity, toughness, moisture barrier properties, gas barrier properties, and/or adhesion properties necessary for some food packaging applications.

U.S. Pat. No. 7,135,234 filed on May 21, 2004 to Donnelly et al and assigned to NOVA Chemicals (International) S.A. attempts to solve the adhesion problem regarding a multilayer structure comprising a polyethylene layer and a layer comprising a thermoplastic vinyl aromatic polymer. The assignee of this patent application is a company owned by NOVA Chemicals Corporation who also owns the assignee company of the present invention. This patent application teaches a multilayer structure comprising at least three layers. The first layer comprises at least one polyethylene, which may be a low linear density polyethylene (LLDPE). The second layer comprises a thermoplastic vinyl aromatic polymer selected from the group consisting of a blend of crystal polystyrene and a thermoplastic styrene butadiene copolymer, and an impact modified styrene methyl methacrylate copolymer. A tie layer located between the first and second layers is comprised of three components, which are a blend of a thermoplastic polyolefin, a thermoplastic vinyl aromatic polymer, and a styrenic block copolymer. This multilayer structure, which may be a sheet or a film, requires a tie layer comprising three components, which may not be appropriate for certain packaging applications requiring clarity or transparency.

Films, particularly suitable for packaging foods, are taught in U.S. Pat. No. 4,863,784, and No. 4,863,769 to Lustig, et al. and assigned to Viskase Corporation. These films are co-extruded, heat shrinkable, thermoplastic multilayer films, which may be fabricated into bags for particular use in packaging fresh red meat cuts, frozen chicken, and processed meat products. The film of the former patent comprises first and second layers of a very low-density polyethylene, and a core layer of vinylidene chloride-methyl acrylate copolymer. Again, these films may not be appropriate for certain packaging applications.

Most of the above-described multilayer structures may not provide clarity, stiffness, and impact strength.

It is also known in the art that certain thermoplastic materials provide certain properties. For instance, polyethylene film is known for its moisture barrier properties. Ethylene vinyl alcohol copolymer (EVOH) is used in the co-extruded multilayer packaging field for its outstanding gas or oxygen barrier properties. Polyvinylidene chloride (PVdC) or Saran resins are known for their oxygen barrier properties. Polyethylene terephthalate (PET) is a thermoplastic resin of the polyester family that is used to make beverage, food and other liquid containers and is known for its sealing properties. Polyamides are known for their mechanical properties, such as strength. An example of a polyamide that may be used in the invention is nylon.

It would be desirable to provide an improved multilayer film structure incorporating an improved rubber modified styrene methyl methacrylate copolymer as a first layer and polyethylene as a moisture barrier material for a second layer that can be used in flexible packaging applications and that provides sufficient rigidity, and optionally, has impact, tear resistance, oxygen barrier, and/or adhesive properties, while having clarity or transparency, and which layers remain bonded together instead of separating over time.

### SUMMARY OF THE INVENTION

The present invention has met this need. The present invention provides flexible packaging material comprised of a multilayer film structure comprising:

a first layer comprised of a thermoplastic composition comprising a continuous phase and a dispersed phase, where:

A) the continuous phase contains a polymer composition resulting from the polymerization of a monomer mixture including (i) from about 25 to 75 parts by weight of a styrenic monomer and (ii) from about 25 to 75 parts by weight of an alkyl (meth)acrylate monomer, wherein the alkyl group is a C₁ to C₁₂ linear, branched or cyclic alkyl group, in the presence of the dispersed phase; and

B) the dispersed phase contains from about 2 to about 50 parts by weight of one or more block copolymers selected from diblock and triblock copolymers of styrene-butadiene, styrene-butadiene-styrene, styrene-isoprene, styrene-isoprene-styrene, partially hydrogenated styrene-isoprene-styrene, for a total of 100 parts by weight of the combination of A) and B). A second layer may be comprised of a moisture barrier material, and a tie layer located between the first layer and the second layer is made of a material selected from, but not limited to, the group consisting of styrene butadiene block copolymers, ethylene vinyl acetate resins, and maleic hydride modified ethylene vinyl acetate resins.

In a further embodiment, the present invention is directed to multilayer thermoplastic packaging articles, for example, flexible stand up pouches, laminating films, and sealing/lidding stocks made from the above-described flexible packaging material.

A further embodiment of the present invention provides a process for preparing flexible packaging material comprised of a multilayer film structure comprised of a first layer comprised of the above-described thermoplastic composition, a second layer, and a tie layer located between the first layer and the second layer, including the steps of:

co-extruding the first layer, the second layer and tie layer to form the multilayer film structure, and

for the second layer, using moisture barrier material, and for the first tie layer using material selected from, but not limited to, the group consisting of styrene butadiene block copolymers, ethylene vinyl acetate resins, and maleic hydride modified ethylene vinyl acetate resins.

The co-extrusion process may include a conventional extrusion process, a blown film process, a cast film process, a lamination process, and a coating process.

An additional embodiment of the present invention is directed to a process for manufacturing flexible packaging articles, for example, stand up pouches, laminating films, and sealing/lidding stocks, including the step of using the packaging material obtained according to the above-described process.

The multilayer film structure of the invention may also be comprised of more than three layers, and as many as five or more layers. For example, depending on the desire properties for a stand up pouch, an inner layer and a second tie layer may be located between the first tie layer and the second layer. This inner layer may be comprised of an oxygen barrier material, for example, ethylene vinyl alcohol copolymers, or a material with mechanical enhancement properties selected from the group consisting of polyester and polyamides, e.g., nylon, or a material with adhesive properties, for example, polyethylene terephthalate. The number of layers and the types of materials used for at least any of the inner layers will depend on the required properties for the packaging article. In most instances, an appropriate tie layer or tie layers will be made of ethylene vinyl acetate (EVA) resins.

In some embodiments, the multilayer film structure may be comprised of at least five layers where the first layer is an inner layer. In this instance, a tie layer and a second layer are located adjacent to and on the one side of the inner layer and a third layer and a tie layer are located adjacent to and on the other side of the inner layer. In this instance, the inner layer may be comprised of the thermoplastic composition, i.e., the rubber modified styrene methyl methacrylate resin; the second layer and the third layer may be comprised of the moisture barrier material, e.g., polyethylene; and the two tie layers may be comprised of ethylene vinyl acetate resins.

In a preferred embodiment, the first layer generally will be comprised of an improved rubber modified styrene acrylic copolymer, e.g., styrene methyl methacrylate copolymer having a 1% secant modulus according to ASTM D 882 typically over 800 MPa and in some instances over 1000 MPa, and the second layer generally will be comprised of polyethylene having a 1% secant modulus according to ASTM D 882 typically greater than about 100 MPa. In most instances, the 1% secant modulus for any formed multilayer film structure of the invention will be greater than 800 MPa.

If an inner layer is made of an oxygen barrier material, for example, polyvinylidene chloride (PVdC), then in most instances a tie layer or layers may not be needed in the multilayer film structure.

These and other objects of the present invention will be better appreciated and understood by those skilled in the art from the following description and appended claims.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about.” Accordingly, unless indicated to the contrary, the numerical parameters set forth in the following specification and attached claims are approximations that may vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term multilayer film structure is comprised of at least two layers and is defined as a thermoplastic film having a thickness ranging from about 0.35 mils to generally no more than 10 mils, preferably 5 mils, and more preferably 3 mils.

As used herein, the multilayer film structure may be used to form flexible packaging material, which, in turn, may be used to form packaging articles, for example, stand-up pouches, inner liners for cereal and cracker products, food service hot-fill pouches, over-wrap for towels and tissues, processed meat forming film, frozen vegetables packages, laminating films and sealing/lidding stocks.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

As used herein, the term “polymer” is meant to encompass, without limitation, homopolymers, copolymers and graft copolymers.

Unless otherwise specified, all molecular weight values are determined using gel permeation chromatography (GPC) using appropriate polystyrene standards. Unless otherwise indicated, the molecular weight values indicated herein are weight average molecular weights (Mw).

In one embodiment, a packaging material is comprised of a multilayer film structure comprising a first layer comprised of an improved rubber modified thermoplastic composition, a second layer, preferably comprised of a moisture barrier material, and a first tie layer made of material selected from the group consisting of styrene butadiene block copolymers, ethylene vinyl acetate resins, and maleic hydride modified ethylene vinyl acetate resins, and the film structure has a thickness ranging from about 0.35 mils to about 3.0 mils.

In making the first layer of the multilayer film structure of the invention, a particular thermoplastic composition is used. The improved thermoplastic composition is characterized as having a continuous phase and a dispersed phase. The continuous phase contains a polymer composition resulting from the polymerization of a monomer mixture containing styrenic and alkyl (meth)acrylate monomers in the presence of the dispersed phase. This thermoplastic composition is taught in United States Patent Application Publication No. 2006-0155063 filed Jan. 12, 2005 to John C. Kwok et al and assigned to NOVA Chemicals, Inc., who is the same assignee of the present invention. In United States Patent Application Publication No. 2006-0155063, the composition is used in disposable card applications. The teachings of this United States Patent Application Publication No. 2006-0155063 are incorporated herein in their entirety, as being used in packaging material of the invention.

In the thermoplastic composition, the styrenic monomers are present in the monomer mixture at a level of at least 25, in some cases at least 30 and in other cases at least 35 parts by weight based on the combined weight of the monomer mixture and the dispersed phase. Also, the styrenic monomers are present in the monomer mixture at a level of up to 75, in some cases up to 70, in other cases up to 65, in some instances up to 60, in other instances up to 55 and in particular situations up to 50 parts by weight based on the combined weight of the monomer mixture and dispersed phase. The amount of styrenic monomer is determined based on the physical properties desired in the resulting thermoplastic sheet. The amount of styrenic monomer in the monomer mixture can be any value recited above or can range between any of the values recited above.

The alkyl (meth)acrylate monomers are present in the monomer mixture at a level of at least 25, in some cases at least 30 and in other cases at least 35 parts by weight based on the combined weight of the monomer mixture and dispersed phase. Also, the alkyl (meth)acrylate monomers are present in the monomer mixture at a level of up to 75, in some cases up to 70, in other cases up to 65, in some instances up to 60, in other instances up to 55 and in particular situations up to 50 parts by weight based on the combined weight of the monomer mixture and dispersed phase. The amount and type of alkyl (meth)acrylate monomers is determined based on the physical properties desired in the resulting thermoplastic sheet. The alkyl group in the alkyl (meth)acrylate monomers can be a C₁ to C₁₂, in some cases a C₁ to C₈ and in other cases a C₁ to C₄ linear, branched or cyclic alkyl group. The amount and type of alkyl (meth)acrylate monomers in the monomer mixture can be any value recited above or can range between any of the values recited above.

In an embodiment of the invention, the styrenic monomer is selected from styrene, p-methyl styrene, tertiary butyl styrene, dimethyl styrene, nuclear brominated or chlorinated derivatives thereof and combinations thereof. In a preferred embodiment, the styrenic monomer is styrene.

In another embodiment of the invention, the alkyl (meth)acrylate monomers include methylmethacrylate and optionally butyl acrylate. In a preferred embodiment, the alkyl (meth)acrylate monomer is methyl methacrylate.

In an embodiment of the invention, the monomer mixture includes one or more chain transfer agents. Any chain transfer agent that effectively controls the molecular weight of the styrenic/alkyl (meth)acrylate copolymers can be used in the invention. Non-limiting examples of suitable chain transfer agents include alkyl mercaptans according to the structure R—SH, where R represents a C₁ to C₃₂ linear, branched or cyclic alkyl or alkenyl group; mercaptoacids according to the structure HS—R—COOX, where R is as defined above and X is H, a metal ion, N+H₄ or a cationic amine salt; dimers or cross-dimers of α-methylstyrene, methyl methacrylate, hydroxy ethylacrylate, benzyl methacrylate, allyl methacrylate, methacrylonitrile, glycidyl methacrylate, methacrylic acid, tert-butyl methacrylate, isocyanatoethyl methacrylate, meta-isopropenyl-α,α-dimethyl isocyanate, ω-sulfoxyalkyl methacrylates and alkali salts thereof. Suitable dimers that can be used in the invention are disclosed, for example, in U.S. Pat. No. 7,022,762, the relevant portions of which are herein incorporated herein by reference.

When used, the one or more chain transfer agents may be present in the monomer mixture at a level of from at least 0.001 wt. %, in some cases at least 0.01 wt. % and in other cases at least 0.1 wt. % and up to 10 wt. %, in some cases up to 7.5 wt. % and in other cases up to 5 wt. % of the monomer mixture. The amount of chain transfer agent can be any value or can range between any of the values recited above.

The dispersed phase is present in the thermoplastic composition at a level of at least 2 parts by weight, in some cases at least 3 parts by weight, in other cases at least 5 parts by weight, and in some situations at least 10 parts by weight based on the combined weight of the monomer mixture and dispersed phase. Also, the dispersed phase is present in the thermoplastic composition for the first layer of the multilayer structure at a level of up to 50 parts by weight, in some cases up to 45 parts by weight, in other cases up to 40 parts by weight, in some instances up to 35 parts by weight, in other instances up to 30 parts by weight, and in particular situations up to 25 parts by weight based on the combined weight of the monomer mixture and dispersed phase. The amount of dispersed phase is determined based on the physical properties desired in the resulting thermoplastic sheet. The amount of dispersed phase in the thermoplastic composition can be any value recited above or can range between any of the values recited above.

The dispersed phase desirably contains one or more block copolymers, which can be rubbery block copolymers. Desirably, the block copolymers include one or more di-block and tri-block copolymers of styrene-butadiene, styrene-butadiene-styrene, styrene-isoprene, styrene-isoprene-styrene and partially hydrogenated styrene-isoprene-styrene. Examples of suitable block copolymers include, but are not limited to, the STEREON® block copolymers available from the Firestone Tire and Rubber Company, Akron, Ohio; the ASAPRENE™ block copolymers available from Asahi Kasei Chemicals Corporation, Tokyo, Japan; the KRATON® block copolymers available from Kraton Polymers, Houston, Tex.; and the VECTOR® block copolymers available from Dexco Polymers LP, Houston, Tex.

In an embodiment of the invention, the block copolymer is a linear or radial block copolymer.

In an embodiment of the invention, the block copolymer has a weight average molecular weight of at least 50,000 and in some cases not less than about 75,000, and can be up to 500,000, in some cases up to 400,000 and in other cases up to 300,000. The weight average molecular weight of the block copolymer can be any value or can range between any of the values recited above.

In another embodiment of the invention, the block copolymer is a triblock styrene-butadiene-styrene or styrene-isoprene-styrene copolymer having a weight average molecular weight of from about 175,000 to about 275,000.

In a further embodiment of the invention, at least some of the polymers in the continuous phase are grafted onto the block copolymer in the dispersed phase.

In an embodiment of the invention, the dispersed phase is present as discrete particles dispersed within the continuous phase. Further to this embodiment, the volume average particle size of the dispersed phase in the continuous phase is at least about 0.1 μm, in some cases at least 0.2 μm and in other cases at least 0.25 μm. Also, the volume average particle size of the dispersed phase in the continuous phase can be up to about 2 μm, in some cases up to 1.5 μm and in other cases up to 1 μm. The particle size of the dispersed phase in the continuous phase can be any value recited above and can range between any of the values recited above.

In another embodiment of the invention, the aspect ratio of the discrete particles is from at least about 1, in some cases at least about 1.5 and in other cases at least about 2 and can be up to about 5, in some cases up to about 4 and in other cases at least up to about 3. When the aspect ratio of the dispersed particles is too large, the resulting thermoplastic sheet is hazy and not clear or transparent. The aspect ratio of the dispersed discrete particles can be any value or range between any of the values recited above. As a non-limiting example, the aspect ratio can be measured by scanning electron microscopy or light scattering.

The particle size and aspect ratio of the dispersed phase can be determined using low angle light scattering. As a non-limiting example, a Model LA-910 Laser Diffraction Particle Size Analyzer available from Horiba Ltd., Kyoto, Japan can be used. As a non-limiting example, a rubber-modified polystyrene sample can be dispersed in methyl ethyl ketone. The suspended rubber particles can then be placed in a glass cell and subjected to light scattering. The scattered light from the particles in the cell can be passed through a condenser lens and converted into electric signals by detectors located around the sample cell. As a non-limiting example, a He—Ne laser and/or a tungsten lamp can be used to supply light with a shorter wavelength. Particle size distribution can be calculated based on Mie scattering theory from the angular measurement of the scattered light.

The thermoplastic composition is formed by dispersing the dispersed phase in a monomer mixture containing styrenic and alkyl (meth)acrylate monomers, de-aerating or sparging with nitrogen, while mixing and adding a suitable free radical polymerization initiator at a suitable temperature to effect free radical polymerization. In an embodiment of the invention, at least some of the monomer mixture reacts with unsaturated groups in the dispersed phase to provide grafting to the dispersed phase. Methods for polymerizing the monomer mixture and dispersed phase are known in the art. Examples of such methods are disclosed in, as non-limiting examples, U.S. Pat. Nos. 4,772,667 to Biletch et al., and 5,891,962 to Otsuzuki et al., the relevant portions of which are herein incorporated by reference. Desirably, the manufacturing conditions are adapted to provide thermoplastic compositions, thermoplastic films and thermoplastic items having the properties described herein.

Any suitable polymerization initiator can be used in the invention. Non-limiting examples of suitable polymerization initiators include dibenzoyl peroxide, di-tert-butyl peroxide, dilauryl peroxide, dicumyl peroxide, didecanoyl peroxide, tert-butyl peroxy-2-ethylhexanoate, tert-butyl perpivalate, tert-butyl peroxyacetate, or butyl peroxybenzoate and also azo compounds, e.g., 2,2′-azobis(2,4-dimethylvaleronitrile), 2,2-azobis-(isobutyronitrile), 2,2′-azobis(2,3-dimethylbutyronitrile), 1,1′-azobis-(1-cyclohexanenitrile), as well as combinations of any of the above.

In an embodiment of the invention, the difference between the refractive index of the continuous phase and the dispersed phase is not more than 0.01 and in some cases not more than 0.001.

Optionally, pigments or colorants or both can be included in the improved thermoplastic composition for the first layer of the multilayer structure of the invention. As non-limiting examples, the pigments and/or colorants can include titanium dioxide. The pigments and/or colorants when added to the thermoplastic composition will generally result in an opaque sheet. A clear or transparent first layer may be defined as having Haze values of 40% or less, and it is known to those skilled in the art that Haze values generally do not apply to an opaque sheet.

As used herein, “pigments and/or colorants” refer to any suitable inorganic or organic pigment or organic dyestuff. Suitable pigments and/or colorants are those that do not adversely impact the desirable physical properties of the thermoplastic sheet. Non-limiting examples of inorganic pigments include titanium dioxide, iron oxide, zinc chromate, cadmium sulfides, chromium oxides and sodium aluminum silicate complexes. Non-limiting examples of organic type pigments include azo and diazo pigments, carbon black, phthalocyanines, quinacridone pigments, perylene pigments, isoindolinone, anthraquinones, thioindigo and solvent dyes.

The thermoplastic composition of the first layer of the multilayer film structure can optionally include one or more additives selected from lubricants, fillers, light stabilizers, heat stabilizers, surface-active agents, and combinations thereof. These additives, when added to the thermoplastic composition may generally result in an opaque sheet.

Suitable fillers are those that do not adversely impact, and in some cases enhance, the desirable physical properties of the thermoplastic first layer of the inventive film structure. Suitable fillers include, but are not limited to, calcium carbonate in ground and precipitated form, barium sulfate, talc, glass, clays such as kaolin and montmorillonites, mica, and combinations thereof.

Suitable lubricants include, but are not limited to, ester waxes such as the glycerol types, the polymeric complex esters, the oxidized polyethylene type ester waxes and the like, metallic stearates such as barium, calcium, magnesium, zinc and aluminum stearate, and/or combinations thereof.

Generally, any conventional ultra-violet light (UV) stabilizer known in the art can be utilized in the present invention. Non-limiting examples of suitable UV stabilizers include 2-hydroxy-4-(octyloxy)-benzophenone, 2-hydroxy-4-(octyl oxy)-phenyl phenyl-methanone, 2-(2′-hydroxy-3,5′-di-teramylphenyl)benzotriazole, and the family of UV stabilizers available under the trade TINUVIN® from Ciba Specialty Chemicals Co., Tarrytown, N.Y.

Heat stabilizers that can be used in the invention include, but are not limited to, hindered phenols, non-limiting examples being the IRGANOX® stabilizers and antioxidants available from Ciba Specialty Chemicals.

When any or all of the indicated additives are used in the first layer of the inventive film structure, they can be used at a level of at least 0.01 weight percent, in some cases at least 0.1 weight percent and in other cases at least 0.5 and up to 10 weight percent, in some cases up to 7.5 weight percent, in other cases up to 5 weight percent, and in some situations up to 2.5 weight percent of the thermoplastic composition and/or the thermoplastic sheet of the invention. The amount, type and combination of additives used will depend on the particular properties desired in the first layer of the inventive film structure. The amount of any single additive or any combination of additives can be any value recited above and can range between any of the values recited above.

Thorough mixing and dispersion of the additive in the thermoplastic composition is important, but otherwise processing conditions are similar to those typically employed in the art.

The thermoplastic composition for the first layer of the inventive film structure is prepared by working the above-described thermoplastic composition to form the thermoplastic layer. Desirably, the thermoplastic composition, along with any desired additives and/or other polymers are combined, may be mixed on a heated mill roll or other compounding equipment, and the mixture cooled, granulated and extruded along with other compositions, which will be discussed herein above, into a multilayer film structure. The formulation may be admixed in extruders, such as single-screw or double-screw extruders, compounded and extruded into pellets, which may be then re-fabricated. A co-extruder is then used to form the multilayer firm structure, more about which will be discussed herein below.

In an embodiment, the second layer of the multilayer film structure of the invention is comprised of moisture barrier material, which preferably, is a polyolefin. Even though one of many polyolefins may be used, the invention will be described in terms of polyethylene. A suitable polyethylene is a film-grade octane copolymer linear low-density polyethylene.

A preferred polyethylene is a homopolymer of ethylene or copolymers of ethylene with a minor amount, i.e., less than 15 mole %, of at least one alpha olefin selected from the group consisting of butane, hexane, and octane. Preferred polyethylene may be prepared by any of the so-called “high pressure” process; slurry process; solution process and/or gas phase process, and with the use of any of the known catalysts, including the so-called Ziegler Natta catalysts; chromium or Phillips catalysts; single site catalysts; and metallocene catalysts. Highly preferred polyethylene is linear low density polyethylene (LLDPE) having a melt index as determined by ASTM standard test D1238 at 190° C. under a 2.16 kilogram load, of from 0.3 to 20 grams per 10 minutes, especially from 0.5 to 5 grams per 10 minutes, and a density of from 0.900 to 0.945 grams per cubic centimeter (g/cc), especially from 0.915 to 0.940 g/cc.

Such LLDPE polymers are typically copolymers of ethylene with a small amount of at least one co-monomer selected from butene, hexane, and octane. Suitable LLDPE polymers are those available under the trade names HPs 900-C, FP112-A, and FP120 Series commercially available from NOVA Chemicals Corporation in Calgary, Alberta, Canada.

The first tie layer of the multilayer film structures according to the invention is located between the first layer, which is comprised of the thermoplastic composition, which as described herein above may be essentially an improved rubber modified styrene methyl methyacrylate copolymer, and the second layer, which is comprised preferably of polyethylene. This first tie layer may be made of material selected from the group consisting of styrene butadiene block copolymers, ethylene vinyl acetate resins, and maleic hydride modified ethylene vinyl acetate resins. Preferably, the first tie layer is comprised of about 100 percent by weight of the aforesaid material based on the weight of the first tie layer.

The styrenic block copolymers for the first tie layer is a copolymer of at least one vinyl aromatic monomer with styrene being preferred, and at least one other olefin or diolefin monomer, especially, C₄ to C₆ conjugated diene, with butadiene and/or isoprene being preferred. The unsaturation in the styrene-conjugated diene block copolymers may optionally be hydrogenated. Such copolymers are reported to be prepared by “block” polymerization using an anionic imitator, such as alkyl lithium, especially butyl lithium. In a “block” polymerization, one monomer, e.g., the vinyl aromatic monomer is initially polymerized, followed by the polymerization of the other monomer, e.g., butadiene. The resulting “blocks” of styrene polymer and butadiene polymer can provide a styrenic block copolymer. These polymers may be di-block, e.g. styrene/butadiene or multi-block e.g. styrene/butadiene/styrene. Preferred styrenic block copolymers for use in the second layer of the film structure of the invention contain blocks of styrene and blocks of butadiene with from about 35 to 55 weight % bound styrene and a number average molecular weight of from about 50,000 to about 100,000. Such styrenic block copolymers are available under the trademark KRATON™ from Kraton Polymers U.S. L.L.C. of Houston, Tex. and under the trademark K-Resin® available from Chevron Phillips Chemical Company, Houston, Tex.

Additional materials that may be used for the first tie layer include ethylene vinyl acetate (EVA) resins and maleic hydride modified ethylene vinyl acetate (EVA) resins. The ethylene-vinyl acetate-maleic anhydride terpolymer may contain at least 50 mol % ethylene repeating units up to 40 mol % vinyl acetate repeating units and up to 10 mol % maleic anhydride repeating units. The ethylene-vinyl acetate-maleic anhydride terpolymer may contain about 5 to 30 mol % vinyl acetate repeating units with about 10 to 15 mol % being most preferred. The ethylene-vinyl acetate-maleic anhydride terpolymer may contain about 0.2 to 5 mol % maleic anhydride repeating units with about 0.2 to 2 mol % being most preferred. The ethylene-vinyl acetate-maleic anhydride terpolymer (before cross-linking) preferably has a melt index of 3 to 50 g/10 min at 190° C., more preferably about 3 to 20 g/10 min with a melt index of about 10 g/10 min being most preferred. The melt index of the ethylene-vinyl acetate-maleic anhydride terpolymer is preferably as close as possible to the melt indexes of both the improved thermoplastic composition, i.e., styrene methyl methacrylate for better adhesion of the tie layer to this first layer and the second layer, i.e., polyethylene. Suitable maleic anhydride modified ethylene vinyl acetate resins are available from Equistar Chemicals, LP, a company of Lyondell Chemical Company, Houston, Tex. under the trade name PLEXAR® PX 1007 and PLEXAR® PX 1164.

Appropriate ethylene vinyl acetate copolymers that may be used as material in the first tie layer may be random ethylene vinyl acetate copolymers obtained by high pressure radical polymerization with the structure:

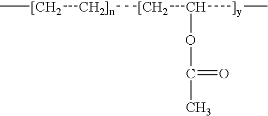

The co-monomer content of these ethylene vinyl acetate resins range from about 18 to about 40% by weight with a melt flow index of about 3 to 800 g/10 nm (190° C.-2.16 kg) sq. The vinyl acetate content of these resins range from about 20 to about 30% by weight, have a melt flow index ranging from about 2.5 to about 30 g/10 nm, and a melting point of ranging from about 70° C. to about 80° C. Suitable ethylene vinyl acetate resins are those commercially available under the trade name ELVAX® from Dupont Company or ULTRATHENE® from Equistar Chemicals.

The multilayer film structure may be comprised of as many as three layers, and in some instances, as many as five layers or higher. In this latter instance, at least one inner layer extends adjacent to the first tie layer, and a second tie layer extends adjacent to and between the second layer and the one inner layer. In one embodiment, this inner layer may be an oxygen barrier material, for example, ethylene vinyl alcohol copolymer, and the second tie layer may be comprised of ethylene vinyl acetate resins, such as those described herein above. In another embodiment, this inner layer may be material having mechanical enhancement properties selected from the group consisting of polyesters and polyamides, and the second tie layer may be comprised of maleic hydride modified ethylene vinyl acetate resins or ethylene vinyl acetate resins, such as those described herein above.

Preferably, the material with mechanical enhancement properties is a polyamide. In a further embodiment, this inner layer may be material having adhesive properties and may be comprised of polyethylene terephthalate, and the second tie layer may be comprised of ethylene vinyl acetate resins or maleic hydride modified ethylene vinyl acetate resins.

In another embodiment, the multilayer film structure may be comprised of three layers, i.e., a first layer and a second layer and an inner layer between the first and second layers. In this embodiment, a first layer is comprised of the thermoplastic composition discussed herein above, a second layer is comprised preferably of polyethylene, and an inner layer is comprised of an oxygen barrier material, preferably, polyvinylidene chloride (PVdC) material. A suitable PVdC is available from Dow Chemical Co. under the trade name Saran®.

In the multilayer film structures, the first layer may comprise about 10% to about 90% of the thickness of the film structure, the second layer may comprise about 90% to about 10% of the thickness of the film structure, and the tie layer may comprise about 5% to about 20% of the thickness of the film.

The inventive multilayer film structure regardless of whether it contains three layers or five layers, or more can be co-extruded or laminated at a temperature that allows for formation of a film structure with the desired physical properties. In one embodiment of the invention, the multilayer film structure is co-extruded at from at least about 400° F. (204° C.), in some cases at least about 450° F. (232° C.) and up to about 550° F. (288° C.), in some cases up to about 5000 (260° C.). The extrusion temperature can be any temperature or range between any of the temperatures indicated above.

The multilayer film structure may be treated with additives after forming such as appropriate heat-seal adhesives, coatings for ink adhesions, printing, labels, and the like.

In an embodiment of the invention, a clear multilayer film structure is desired and/or required. For clear or transparent multilayer film structures, the multilayer film structure has a Haze value of from at least about 0.01% and can be up to about 40%, in some cases 20%, in other cases 10%, in other cases 5% and in some situations 3%. The Haze value of a film structure sample can be measured according to ASTM D 1003 which involves using a Color Quest® XE-Touch reflectance/transmittance spectrophotometer equipped with Universal® color quality control software, available from Hunter Associates Laboratory, Inc., Reston, Va. The Haze value of the multilayer film structure can be any value, or can range between any of the values recited above.

In an embodiment of the invention, the tensile strength (tensile break) of the multilayer film structure is at least about 3,500 psi, in some cases at least about 4,000 psi and in other cases at least about 5,000 psi and can be up to about 10,000 psi, in some cases up to 9,000 psi, in other cases up to 8,000 psi and in some situations up to 7,000 psi measured according to ASTM D-882. The tensile strength of the multilayer film structure can be any value, or can range between any of the values recited above.

In an embodiment of the invention, the 1% secant modulus of the multilayer film structure is at least about 500 MPa, in some cases at least about 600 MPa, and in other cases at least about 700 MPa, and can be up to about 900 MPa, in some cases up to 1,000 MPa, in other cases up to 2,000 MPa and in some situations up to 3,000 MPa measured according to ASTM D-882. The 1% secant modulus of the multilayer film structure can be any value, or can range between any of the values recited above.

The tear strength of the multilayer film structure of the invention will depend on the percentage of the layer components and the types of materials used in the layer components comprising the layers of the multilayer film structure. In some cases, the tear strength may range from about 5 g/mil to about 500 g/mil as measured according to ASTM D-882. The tear strength can be any value, or can range between any of the values recited above.

The break at elongation of the multilayer film structure of the invention will depend on the percentage of the layer components and the types of materials used in the layer components comprising the layers of the film structure. In an embodiment of the invention, the multilayer film structure can have a break at elongation of at least about 5%, in some cases at least about 50%, and in other cases at least about 100% and can be up to about 200%, in some cases up to 300%, and in other cases up to 800% as measured according to ASTM D-882. The elongation at break can be any value, or can range between any of the values recited above.

In an embodiment of the invention, the multilayer film structure can have a thickness of at least about 0.35 mils and in other cases at least about 0.5 mils and can be up to about 3 mils, in some case up to about 5 mils, in some cases up to about 10 mils. The thickness of the multilayer film structure can vary depending on its intended use. The thickness of the film structure can be any value or can range between any of the values recited above.

Aspects of the present invention also provide a process for preparing flexible packaging material comprised of a first layer, a second layer, and a tie layer located between the first layer and the second layer, including the steps of co-extruding the first layer with the second layer and the tie layer to form the multilayer film structure of the invention having a thickness ranging from about 0.35 mils to about 10.0 mils; and for the second layer, using moisture barrier material, and for the tie layer using material selected from the group consisting of, but not limited to, styrene butadiene block copolymers, ethylene vinyl acetate resins, and maleic hydride modified ethylene vinyl acetate resins.

Further embodiments include co-extruding an inner layer and a second tie layer to form a five layer multilayer film structure or co-extruding an inner layer between a first layer and a second layer, which requires no tie layer, as discussed herein above.

Further embodiments include co-extruding a multilayer film structure comprised of at least five layers where the inner layer is comprised of the improved thermoplastic composition of the invention, e.g., improved rubber modified styrene methyl methacrylate copolymer; the two outer layers are comprised of a moisture barrier material, e.g., polyethylene, and the tie layers between the inner layer and each of the outer layers are comprised of ethylene vinyl acetate resins.

The co-extruding process may include a process selected from the group, but not limited to, consisting of a conventional extrusion process, a blown film process, a cast film process, a coating process, and a laminating process.

These several processes are well known to those skilled in the art. In general, the conventional extrusion process includes compacting and melting a plastic material and forcing it through an orifice in a continuous fashion. The material is conveyed through the heated machine barrel by a helical screw, where it is heated and mixed to a homogeneous state and then forced through a die of the shape required for the finished product.

The blown film process involves extruding a continuous thin-walled tube of plastic and inflating it immediately after it leaves the die. The pressure is such that the tube stretches, increasing its diameter and reducing its wall thickness to a desired gauge. Air is trapped within the blown tube (bubble) between the die and the collapsing rolls, which convert the blown tube into a lay-flat film to facilitate winding onto a roll.

In a cast film process, the polymer is extruded from a slot die onto the surface of a water-cooled roll. The film is clearer and has more sparkle than a blown film. The cast film is, in essence, an extruded film.

The coating process involves coating a substrate by extruding a thin film of molten polymer and pressing it onto the substrate. A lamination process involves pressing a film substrate onto a thin film of molten polymer.

Further embodiments include a method for manufacturing a flexible packaging article including the step of using the packaging material in a conventional form, fill and seal process to manufacture desired articles similar to those described herein above.

A further embodiment includes a multilayer thermoplastic packaging article made from the flexible packaging material as described herein above comprising a first layer comprised of the improved rubber modified styrene acrylic copolymer that imparts cold temperature toughness, wherein the packaging material can be effectively used in temperatures ranging from a cold refrigeration temperature to a freezer temperature range.

The present invention will further be described by reference to the following examples. The following examples are merely illustrative of the invention and are not intended to be limiting. Unless otherwise indicated, all percentages are by weight.

### EXAMPLES

The test methods used to evaluate the multilayer film structures were:
1% Secant Modulus—ASTM D-882
Elongation at Break—ASTM D-882
Tear Strength—ASTM D-882
Tensile Strength—ASTM D-882
Haze of a film sample was measured using a ColorQuest® XE-Touch reflectance/transmittance spectrophotometer equipped with Universal Software® color quality control software, available from Hunter Associates Laboratory, Inc., Reston, Va.—ASTM D-1003.

### Examples 1-5

### Blown Film

One and three layer film structures were prepared using a conventional co-extrusion blown film line (manufactured by Brampton Engineering).

The one and three layer circular dies were tapered or “streamlined” with a base diameter of about 6 inches (about 15 centimeters) and an exit lip diameter of about 4 inches (about 10 centimeters). Each die layer was fitted with a 35 mil die pin.

The three-layer die was fed with three extruders, each fitted with an extruder screw having a diameter of about 1% inches (about 4.5 cm) and a length/diameter ratio of 30:1. The one-layer die was fed with one extruder fitted with an extruder screw having a diameter of about 1¼ inches (about 4.5 cm) and a length/diameter ratio of 30:1.

This blown film line was fitted with a chilled air ring and a bubble-stabilizing cage that could be controlled to blow up ratio (“BUR”) of from about 1.5:1 to 4.0:1.

One layer and three layer film structures were prepared using the formulations shown in Table 1. The three layer film structures may be regarded as a proxy for one half of a five-layer structure (i.e., A/B/C is a proxy for A/B/C/B/A). The films were extruded using a BUR of about 2.3:1 to 2.5:1. The total mass flow rate of the resins used to produce the one layer and the three layers was about 100 lbs/hr with the thickness of each layer being controlled by the individual rates of each component. Table 1 shows the percentage of the thickness of each component relative to the total thickness of the film.

Each of the three extruders for the three layer film structures were operated at a temperature aiming point of between 370° F. and 430° F. The one extruder for the one-layer film structures was also operated at a temperature aiming point of between 370° F. and 430° F. The die temperature aiming point was about 400° F. to about 415° F.

The blow-up ratio was about 2.5 to 2.6 for all the Examples 1-5, the air ring temperature was about 60° F., and the frostline was about 8 to 12 inches.

The film structures of Examples 1-4 contain a thermoplastic composition comprised of an improved rubber modified styrene acrylic copolymer (Copolymer). More particularly, this styrene acrylic copolymer is an improved rubber modified styrene methyl methacrylate (SMMA) copolymer of the invention and comprises a continuous phase and a discrete phrase of the invention that was prepared by polymerizing 47 wt. % styrene, 33.5 wt. % methyl methacrylate, and 5 wt. % butyl acrylate in the presence of 14.5 wt. % styrene-butadiene block copolymer with an average styrene content of 39.75 wt. % using tert butyl peroxyacetate as initiator. This improved rubber modified SMMA copolymer is commercially available from NOVA Chemicals Inc., Belpre, Ohio. For Example 1, this improved rubber modified SMMA was then extruded to form a film comprised of a single layer having a 3.7 mils thickness. For Examples 2-4, a three-layer multilayer film structure was co-extruded that varied in thickness from 2.7 to about 3.3 mils. These film structures appear in Table 1 where the indicated percentages are relative to the total thickness of the film structure. Example 5 (Comp) is a comparative example showing the properties for a one-layer film comprised of polyethylene.

Results for Examples 1-5 are shown in Table 1:

TABLE 1

| | | | | | | Example 5 |
|---|---|---|---|---|---|---|
| | | Example 1 | Example 2 | Example 3 | Example 4 | (Comp.) |
| Product | Units | Co- | 15% HPs900C | 70% Copolymer | 40% Copolymer | HPs900C |
| | | Polymer | 70% Copolymer | 15% tie layer | 20% tie layer | |
| | | | 15% HPs900C | 15% HPs900C | 40% HPs900C | |
| Thickness | Mils | 3.7 | 2.7 | 2.9 | 3.3 | 1.0 |
| 1% secant | MPa | 1703 | 1065 | 1402 | 1053 | 135 |
| modulus MD | | | | | | |
| 1% secant | MPa | 1722 | 1223 | 1285 | 1040 | 155 |
| modulus TD | | | | | | |
| Tear Strength | G/mil | 7 | 141 | 6.4 | 8.7 | 280 |
| MD | | | | | | |
| Tear Strength | G/mil | 6 | 149 | 6.7 | 8.3 | 445 |
| TD | | | | | | |
| Tensile strength | MPa | 36.5 | * | 31.1 | 23.6 | 49 |
| MD | | | | | | |
| Elongation MD | % | 4.3 | * | 10.7 | 34.4 | 520 |
| Tensile Strength | MPa | 35.6 | * | 29.4 | 24 | 43 |
| TD | | | | | | |
| Elongation TD | % | 5.1 | * | 8.4 | 17.7 | 750 |

* Samples delaminated, i.e. no adhesion between copolymer and polyethylene without a tie layer
HPs 900C - a linear low density polyethylene available from NOVA Chemicals
Copolymer - An improved rubber modified styrene methyl methacrylate (SMMA) copolymer.
Tie layer - ELVAX ®, ethylene vinyl acetate (EVA) resin
% in the multilayer film structure denotes the percentage of the layer relative to the total thickness of the film

MD denotes the machine direction of the film. TD denotes the transverse direction of the film. The thermoplastic films made with the rubber modified styrene acrylic copolymer as an outer layer and HPs900 C as an outer layer, and an EVA resin as a tie layer were stiffer than a film containing a single layer comprised of polyethylene.

Specifically, the key improvement of the invention as shown in Examples 1-4 is that the use of the improved rubber modified styrene acrylic copolymer, e.g., rubber modified SMMA copolymer, of the invention imparts rigidity in the multilayer film structure as indicated by the 1% secant modulus measurements. For example, each of Examples 1-4, containing at least one layer comprised of the improved rubber modified styrene acrylic copolymer, has an improved 1% secant modulus compared to the single layer film of Example 5 that contains polyethylene.

### Examples 6-12

### Co-Extrusion Film Line

One and three layer structures were prepared using a conventional co-extrusion film line (manufactured by Randcastle Company).

The film line was equipped with a three-layer die and a feed block assembly for allowing co-extrusion of five layers of material (A/B/C/B/A) with a 12 inch wide flexible lip flat die. The three-layer die was feed with three extruders, two fitted with a ⅝″ screw and one fitted with a ¾″ screw for the C layer.

The equipment was used in the following manner. To produce the structures of Examples 7 through 10, the copolymer was extruded into the feedblock, which aligns the flow from the extruders into the desired film structure, by using the ¾ inch screw to form the C layer, the tie layer was extruded using one of the ⅝ inch screws to form the B layer, and the polyethylene (FP 120C and FP 112A) material was extruded using the other ⅝ inch screw extruder to form the A layer.

The screw extrusion temperatures ranged from 420° F. to 520° F. with material rates appropriate to yield the desired film layer thickness.

Melt temperatures of 390° F. to 420° F. were used, and the die temperature was about 500° F. The one and three layer film structures were cooled and sized at the die outlet with a chrome roll stack at 120° F. to 135° F. and were processed at rates of about 3 feet/minute.

The film structures of Examples 6-10 contain at least one layer comprised of the improved rubber modified styrene acrylic copolymer of the invention. More specifically, the styrene acrylic copolymer is a rubber modified SMMA copolymer comprising a continuous phase and a discrete phrase of the invention that was prepared by polymerizing 47 wt. % styrene, 33.5 wt. % methyl methacrylate, and 5 wt. % butyl acrylate in the presence of 14.5 wt. % styrene-butadiene block copolymer with an average styrene content of 39.75 wt. % using tert butyl peroxyacetate as initiator. This improved rubber modified SMMA copolymer is commercially available from NOVA Chemicals Inc., Belpre, Ohio.

The thickness of each film structure of Examples 6-10 is 5 mils. Example 6 is a single layer film; whereas Examples 7, 8, 9 and 10 are three layer film structures. Examples 11 and 12 are one-layer films comprising polyethylene. The properties for Examples 6-12 are shown in Table 2.

TABLE 2

| | | | | | Example | Example | Example |
|---|---|---|---|---|---|---|---|
| | Example 6 | Example 7 | Example 8 | Example 9 | 10 | 11 | 12 |
| Product(s) | Co-polymer | FP 120C | FP112A | FP120C | FP112A | FP120C | FP112A |
| | | KR 10 | KR 10 | PX 1007 | PX 1007 | | |
| | | Co- | Co-polymer | Co-polymer | Co-polymer | | |
| | | polymer | | | | | |
| Thickness | 5.0 mils | 5.0 mils | 5.0 mils | 5.0 mils | 5.0 mils | 1.0 mils | 2.0 mils |
| Haze (%) | 13.8 | 9.2 | 8.3 | 8.7 | 8.4 | *10 | *8.7 |
| 1% Secant | 1628 | 1480 | 1282 | 876 | 1049 | 180 | 114 |
| Modulus | | | | | | | |
| (MD) | | | | | | | |
| MPA | | | | | | | |
| 1% Secant | 1605 | 967 | 1062 | 1211 | 1303 | 205 | 123 |
| Modulus | | | | | | | |
| (TD) | | | | | | | |
| MPA | | | | | | | |
| Tear | 9.4 | 7.5 | 14.6 | 80.7 | 60.6 | 460 | 355 |
| Strength | | | | | | | |
| (MD) - g/mil | | | | | | | |
| Tear | 9.4 | 7.6 | 7.6 | 88.1 | 72.6 | 620 | 505 |
| Strength | | | | | | | |
| (MD) - g/mil | | | | | | | |

*Haze was measured on thinner gauge films.
FP 120 C - Polyethylene from NOVA chemicals having a melt index of 1.0 and a density of 0.920
FP 112A - Polyethylene from NOVA Chemicals having a melt index of 0.9 and a density of 0.912
KR 10 - styrene butadiene block copolymer from Chevron Phillips
Copolymer - Rubber modified SMMA available from NOVA Chemicals
Plexar ® PX 1007 - maleic anhydride grafted ethylene vinyl acetate resin available from Equistar Chemicals

Typical 1% secant modulus values for polyethylene is about 200 MPa and the tear strength is about 600 g/mil. The values for these properties for Examples 11 and 12 are generally in line with the typical values.

Again, the improvement in Examples 6-10 is in the rigidity, Haze values, and the good tear strength of the single layer film (Example 6) comprised of the improved rubber modified SMMA copolymer of the invention and the multilayer film structures (Examples 7-19) comprised of at least one layer comprised of the improved rubber modified SMMA copolymer of the invention.

The present invention has been described with reference to specific details of particular embodiments thereof. It is not intended that such details be regarded as limitations upon the scope of the invention except insofar as and to the extent that they are included in the accompanying claims.

What is claimed is:

1. Packaging material comprised of a multilayer film structure comprising a first layer comprised of a thermoplastic composition comprising a continuous phase and a dispersed phase, wherein:
A) the continuous phase comprises a polymer composition resulting from the polymerization of a monomer mixture comprising (i) from about 25 parts by weight to 75 parts by weight of a styrenic monomer and (ii) from about 25 parts by weight to 75 parts by weight of an alkyl (meth)acrylate monomer, wherein the alkyl group is a C₁ to C₁₂ linear, branched or cyclic alkyl group, in the presence of the dispersed phase; and
B) the dispersed phase comprises from about 2 parts by weight to about 50 parts by weight of one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene, for a total of 100 parts by weight of the combination of A) and B).

2. Packaging material of claim 1 wherein said multilayer film structure further comprises:
a second layer comprised of a moisture barrier material, and
a first tie layer extending between said first layer and said second layer and made of material selected from the group consisting of styrene butadiene block copolymers, ethylene vinyl acetate resins, and maleic hydride modified ethylene vinyl acetate resin.

3. Packaging material claim 1 wherein the dispersed phase B) is present as discrete particles dispersed within the continuous phase A).

4. Packaging material of claim 3 wherein the volume average particle size of the dispersed phase B) is from about 0.1 μm to about 2 μm.

5. Packaging material of claim 1 wherein said multilayer film structure has a Haze value ranging between 0.1% and 40%.

6. Packaging material of claim 1 wherein the difference between the refractive index of the continuous phase A) and the dispersed phase B) is not more than 0.01.

7. Packaging material of claim 1 wherein the styrenic monomer is selected from the group consisting of styrene, p-methyl styrene, tertiary butyl styrene, dimethyl styrene, nuclear brominated or chlorinated derivatives thereof and combinations thereof.

8. Packaging material of claim 1 wherein the alkyl (meth)acrylate monomer comprises methyl methacrylate and optionally butyl acrylate.

9. Packaging material of claim 1 wherein the block copolymer has a weight average molecular weight of not less than about 75,000.

10. Packaging material of claim 1 wherein the block copolymer is a linear or radial block copolymer.

11. Packaging material of claim 1 wherein the block copolymer is a tri-block styrene-butadiene-styrene or styrene-isoprene-styrene copolymer having a weight average molecular weight of from about 175,000 to about 275,000.

12. Packaging material of claim 1 wherein at least some of the polymers in A) are grafted onto the block copolymer in B).

13. Packaging material of claim 1 wherein the monomer mixture further comprises a chain transfer agent.

14. Packaging material of claim 2 wherein said multilayer film structure has a thickness ranging from about 0.35 mils to about 10.0 mils.

15. Packaging material of claim 2 wherein said moisture barrier material of said second layer is polyethylene.

16. Packaging material of claim 15 wherein said polyethylene of said second layer is a film-grade octane copolymer linear low density polyethylene

17. Packaging material of claim 2 wherein said multilayer structure further comprises at least one inner layer and a second tie layer extending between said first tie layer and said second layer, and wherein said one inner layer is an oxygen barrier material, and said second tie layer is an ethylene vinyl acetate resin.

18. Packaging material of claim 17 wherein said oxygen barrier material is an ethylene vinyl alcohol copolymer.

19. Packaging material of claim 2 wherein said multilayer structure further comprises at least one inner layer and a second tie layer extending between said first tie layer and said second layer, and wherein said one inner layer is material with mechanical enhancement properties selected from the group consisting of polyesters and polyamides, and said second tie layer is comprised of maleic hydride modified ethylene vinyl acetate resins.

20. Packaging material of claim 19 wherein said material with mechanical enhancement properties comprises polyamides.

21. Packaging material of claim 19 wherein said multilayer film structure has a secant modulus greater than 800 MPa as measured by ASTM D 882.

22. Packaging material of claim 2 wherein said multilayer film structure further comprises at least one inner layer and a second tie layer extending between said first tie layer and said second layer, and wherein said inner layer is material with adhesive properties comprised of polyethylene terephthalate, and said second tie layer is comprised of ethylene vinyl acetate resin.

23. Packaging material of claim 2 wherein said first layer comprises about 10% to about 90% of the thickness of said multilayer film structure, said second layer comprises about 90% to about 10% of said multilayer film structure, and said first tie layer comprises about 5% to about 20% of the thickness of said multilayer film structure.

24. Packaging material comprised of a multilayer film structure comprising a first layer comprised of a thermoplastic composition comprising a continuous phase and a dispersed phase, wherein:
A) the continuous phase comprises a polymer composition resulting from the polymerization of a monomer mixture comprising (i) from about 25 parts by weight to 75 parts by weight of a styrenic monomer and (ii) from about 25 parts by weight to 75 parts by weight of an alkyl (meth)acrylate monomer, wherein the alkyl group is a C₁ to C₁₂ linear, branched or cyclic alkyl group, in the presence of the dispersed phase; and
B) the dispersed phase comprises from about 2 parts by weight to about 50 parts by weight of one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene, for a total of 100 parts by weight of the combination of A) and B), and
a second layer comprised of a moisture barrier material, and
at least one inner layer extending between said first layer and said second layer comprised of oxygen barrier material.

25. Packaging material claim 24 wherein the dispersed phase B) is present as discrete particles dispersed within the continuous phase A).

26. Packaging material of claim 25 wherein the volume average particle size of the dispersed phase B) is from about 0.1 μm to about 2 μm.

27. Packaging material of claim 26 wherein said multilayer film structure has a Haze value ranging between 0.1% and 40%.

28. Packaging material of claim 24 wherein the difference between the refractive index of the continuous phase A) and the dispersed phase B) is not more than 0.01.

29. Packaging material of claim 24 wherein the styrenic monomer is selected from the group consisting of styrene, p-methyl styrene, tertiary butyl styrene, dimethyl styrene, nuclear brominated or chlorinated derivatives thereof and combinations thereof.

30. Packaging material of claim 24 wherein the alkyl (meth)acrylate monomer comprises methylmethacrylate and optionally butyl acrylate.

31. Packaging material of claim 24 wherein the block copolymer has a weight average molecular weight of not less than about 75,000.

32. Packaging material of claim 24 wherein the block copolymer is a linear or radial block copolymer.

33. Packaging material of claim 24 wherein the block copolymer is a tri-block styrene-butadiene-styrene or styrene-isoprene-styrene copolymer having a weight average molecular weight of from about 175,000 to about 275,000.

34. Packaging material of claim 24 wherein at least some of the polymers in A) are grafted onto the block copolymer in B).

35. Packaging material of claim 24 wherein the monomer mixture further comprises a chain transfer agent.

36. Packaging material of claim 24 wherein said moisture barrier material of said second layer is polyethylene.

37. Packaging material of claim 36 wherein said polyethylene of said second layer is a film-grade octane copolymer low linear density polyethylene.

38. Packaging material of claim 24 wherein said multilayer film structure has a thickness ranging from about 0.35 mils to about 10.0 mils.

39. A process for preparing packaging material comprised of a multilayer film structure comprised of at least a first layer, a second layer, and a tie layer located between the first layer and the second layer, including the steps of:
forming a composition for said first layer comprising a continuous phase and a dispersed phase, wherein
A) the continuous phase comprises a polymer composition resulting from the polymerization of a monomer mixture comprising (i) from about 25 to 75 parts by weight of a styrenic monomer and (ii) from about 25 to 75 parts by weight of an alkyl (meth)acrylate monomer, wherein the alkyl group is a C₁ to C₁₂ linear, branched or cyclic alkyl group, in the presence of the dispersed phase; and
B) the dispersed phase comprises from about 2 to about 50 parts by weight of one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene, for a total of 100 parts by weight of the combination of A) and B);
co-extruding the first layer, second layer and tie layer to form the multilayer film structure; and
for the second layer, using moisture barrier material, and for the tie layer using material selected from the group consisting of styrene butadiene block copolymers, ethylene vinyl acetate resins, and maleic hydride modified ethylene vinyl acetate resins.

40. A process of claim 39 wherein said second layer is a moisture barrier material is polyethylene.

41. A process of claim 39 wherein said polyethylene of said second layer is a film-grade octane copolymer linear low density polyethylene.

42. A process of claim 39, the steps further comprising:
co-extruding at least one inner layer and a second tie layer extending between the first tie layer and the second layer, and wherein the one inner layer is oxygen barrier material comprised of ethylene vinyl alcohol copolymer, and said second tie layer is comprised of ethylene vinyl acetate resins.

43. A process of claim 39, the steps further comprising:
co-extruding at least one inner layer and a second tie layer extending between the first tie layer and the second layer, and wherein the one inner layer is material with mechanical enhancement properties selected from the group consisting of polyesters and polyamides and said second tie layer is comprised of maleic hydride modified ethylene vinyl acetate resins.

44. A process of claim 39 wherein the material with mechanical enhancement properties comprises polyamides.

45. A process of claim 39 wherein the multilayer film structure has a secant modulus greater than 800 MPa according to ASTM D 882.

46. A process of claim 39 the steps further comprising:
co-extruding at least one inner layer and a second tie layer extending between the first tie layer and the second layer, and wherein the one inner layer is material with adhesive properties comprised of polyethylene terephthalate, and the second tie layer is comprised of ethylene vinyl acetate resin.

47. A method for manufacturing a packaging article including the step of using the packaging material of claim 39 to form said packaging article.

48. A multilayer thermoplastic packaging article made from the packaging material of claim 2.

49. A multilayer thermoplastic packaging article made from the packaging material of claim 24.

50. A process of claim 39 wherein said co-extruding step includes a process selected from the group consisting of conventional extrusion process, a blown film process, a cast film process, a lamination process, and a coating process.
